(19) United States
(12) Patent Application Publication
(10) Pub. No.: US 2002/0194329 A1
(43) Pub. Date: Dec. 19, 2002

(54) Method and system for facilitating multi-enterprise benchmarking activities and performance analysis

(75) Inventor: Eric R. Alling, Upton, MA (US)

Correspondence Address: S. Matthew Cairns, c/o EDWARDS & ANGELL, LLP, Dike, Bronstein, Roberts & Cushman, IP Group, P.O.Box 9169, Boston, MA, 02209, US

(73) Assignee: Shipley Company, L.L.C., Marlborough, MA (US)

(21) Appl. No.: 10/137,218

(22) Filed: May 2, 2002

Related U.S. Application Data
(60) Provisional application No. 60/288,235, filed on May 2, 2001.

(51) Int. Cl. G06F 15/173

(52) U.S. Cl. 709/224

(57) ABSTRACT

An exemplary embodiment of the invention relates to a web-based method and system for facilitating multi-enterprise benchmarking activities and performance analysis capabilities across an industry. The method comprises receiving metrics data at a web site from multiple equipment devices associated with multiple subscribing enterprises; evaluating the metrics data; providing summary reports to the subscribing enterprises; performing calculations on the summary reports; generating an industry summary report; and providing the industry summary report to the subscribing enterprises for comparative analysis and business planning. The system includes a hosting system for executing the multi-enterprise benchmarking application, subscribing enterprises which are in communication with the hosting system via a network connection, and equipment devices operating within the subscribing enterprises.

### BACKGROUND OF THE INVENTION

The present invention relates generally to enterprise benchmarking, and more particularly, the present invention relates to a web-based method and system for facilitating multi-enterprise benchmarking activities and performance analysis capabilities across an industry.

Business enterprises today are continuously seeking new and improved methods of producing goods and services in order to stay on top of their competitors. With the advent of Internet technologies and the expanding global marketplace fostered by the Internet, staying competitive requires continuously developing new and innovative business methods. Many commercial software providers have developed solutions designed to assist in these endeavors ranging from customized point solutions for solving specific problems to large scale, extensible enterprise resource planning applications. Additionally, applications service providers (ASPs) and commercial applications are abundant in areas such as data warehousing and data mining functions for assisting businesses in making sense of the vast amounts of data collected throughout a production cycle. This information can then be presented in a summarized fashion to provide valuable marketing reports, sales reports, and other useful data. Further, analyzing market trends and linking socio-economic data to these data can provide invaluable insight useful in developing future planning strategies. Measuring changes in these data over time allows management to predict patterns or cycles of behaviors and be more pro-active in adopting or refining business goals. Many businesses today now employ benchmarking techniques whereby performance goals are established relative to specific employees, production cycles or outputs, error reduction processes, etc. These internally devised benchmarks are then compared with actual performance data and analyzed for possible inefficiencies, problem sources, and solutions. Although this information may be quite beneficial, it does not paint a complete picture for the business with respect to how it is performing relative to its competitors.

What businesses today are lacking are useful industry-wide performance data which can be evaluated against established industry-wide benchmarking data in order to determine statistically how a business is performing relative to other businesses which are similarly situated, either geographically or by industry. Benchmarking data provides standards of typical competence units used for the basis of making comparisons. They may be proprietary in that a business adopts its own standards or goals for comparative analysis or may span an entire industry in order to evaluate an individual business' performance levels compared to other similar businesses in that industry. Imagine how useful production metrics analyzed on an industry-wide scale could be to a business involved in that industry. Businesses would be able to measure and compare their performance and production metrics to those of their competitors in order to gain a picture of where they fall within the established industry spectrum. For obvious reasons, however, competitors do not typically release their performance data to outsiders. This type of information is generally confidential in nature and closely guarded.

It is therefore desirable to provide a web-based method and system for facilitating multi-enterprise benchmarking activities and analysis for similarly situated businesses within an industry without jeopardizing the integrity of confidential or proprietary information. Certain information acquired can then be used by these businesses to develop and implement new and improved production processes and business plans.

### BRIEF SUMMARY OF THE INVENTION

An exemplary embodiment of the invention relates to a web-based method and system for facilitating multi-enterprise benchmarking activities and performance analysis capabilities across an industry or region. The method comprises receiving metrics data at a web site from multiple equipment devices associated with multiple subscribing enterprises; evaluating the metrics data; providing summary reports to the subscribing enterprises; performing calculations on the summary reports; generating an industry summary report; and providing the industry summary report to the subscribing enterprises for comparative analysis and business planning. The system includes a hosting system for executing the multi-enterprise benchmarking application, subscribing enterprises which are in communication with the hosting system via a network connection, and equipment devices operating within the subscribing enterprises.

### BRIEF DESCRIPTION OF THE DRAWINGS

The present invention is described below with reference to the following drawing figures of which:

FIG. 1 is a block diagram of a portion of a network system on which the multi-enterprise benchmarking application is implemented in an exemplary embodiment of the present invention;

FIG. 2 is a master database table of account records by industry;

FIG. 3 is a flowchart describing the multi-enterprise benchmarking process as implemented by the multi-enterprise benchmarking tool in a network environment;

FIG. 4 is a flowchart describing the multi-enterprise benchmarking process as implemented by the multi-enterprise benchmarking tool manually executed; and

FIG. 5 is a sample summary report illustrating performance metrics of a subscribing enterprise as compared to other enterprises within an industry.

### DESCRIPTION OF THE PREFERRED EMBODIMENT

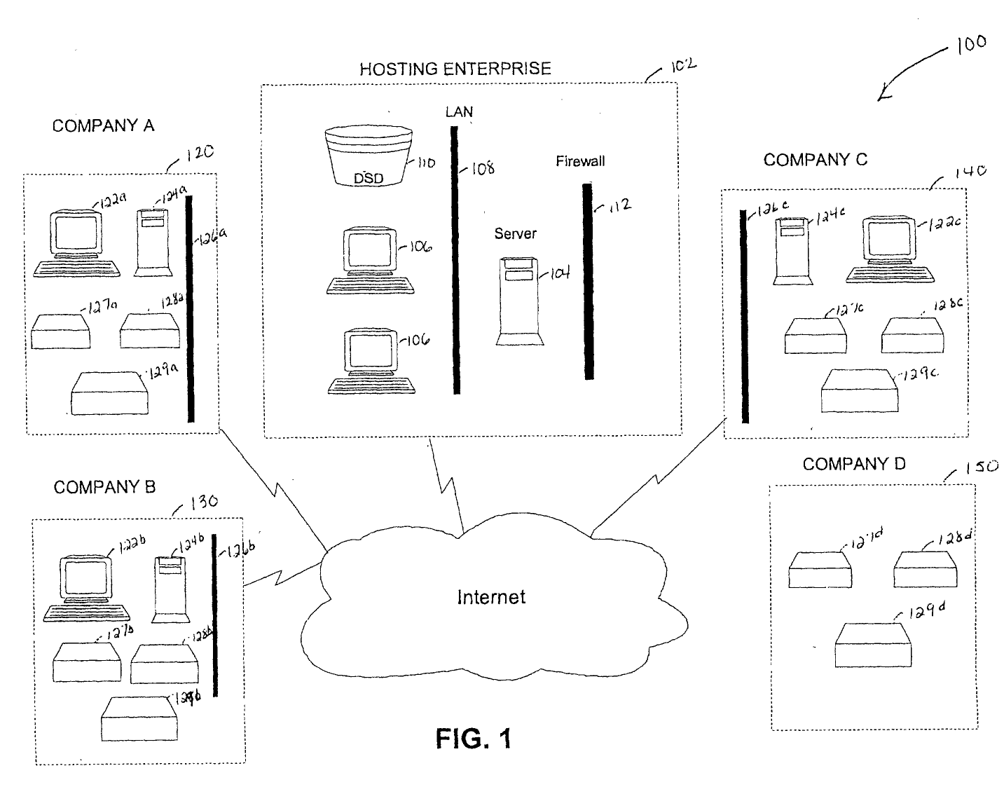

With reference to FIG. 1, a multi-enterprise benchmarking system is discussed. System 100 includes a hosting enterprise 102 including a server 104 in communication with workstations 106 and data storage device 110 via a network connection 108. Server 104 operates web server software suitable for handling general communications protocols and transport layer activities. Web server software running on server 104 may be capable of accommodating various forms of communications including voice, video, and text. Server 104 is also operating applications software such as groupware applications, email software, and the multi-enterprise benchmarking application of the present invention. Workstations 106 receive and send data to server 104 via network 108. Network 108 may comprise a LAN, WAN, or other network configuration known in the art. Further, network 108 may include wireless connections, radio-based technologies, telephony-based communications, and combinations of the above. Workstations 106 may be either personal computers, laptops, personal digital assistants, or any similar communications device known in the art.

Data storage device 110 is any form of mass storage device configured to read and write database type data maintained in a file store (e.g., a magnetic disk data storage device). Of course, it will be appreciated that data storage device 110 may be one that consists of multiple disk sub-systems which may be geographically dispersed and coupled via network architecture. There is no positive requirement that data storage device 110 be maintained in one facility; to the contrary, the volume of information stored therein may dictate geographical dispersion and the like. All that is required is that data storage device 110 be logically addressable as a consolidated data source across a distributed environment such as a network system. The implementation of local and wide-area database management systems to achieve the functionality of data storage device 110 will be readily understood by those skilled in the art. Information stored in data storage device 110 is retrieved and manipulated by an internal database manager. Data storage device 110 houses databases of information used by hosting enterprise 102 including records of subscribing enterprises to the multi-enterprise benchmarking tool, summaries of performance data for individual subscribing enterprises, combined summaries of groups of similarly situated subscribing enterprises by industry and/or geographic region, file histories pertaining to subscribing enterprises, etc. Hosting enterprise 102 also includes a firewall 112 for facilitating secure network communications between external entities and its internal devices. Firewall 112 may be software running on server 104 or may be a separate system device generally known in the art for intercepting and screening incoming data such as gateways, proxy servers, and filters.

Each of subscribing enterprises 120, 130 and 140 is in communication with hosting enterprise 102 via a network connection. Each of subscribing enterprises 120, 130, and 140 comprise a web server 124(a-c), respectively that connects associated workstations 122(a-c) to intranets 126(a-c) respectively and to the Internet. Each of workstations 122(a-c) may access associated web servers 124(a-c) via internal web browsers located on workstations 122(a-c) respectively (not shown). Each of enterprises 120-150 may be an existing or prospective subscriber of hosting enterprise 102 and may be a supplier or manufacturer. Additionally, enterprises 120-150 each include multiple equipment devices. Although three equipment devices 127, 128, and 129 are shown in

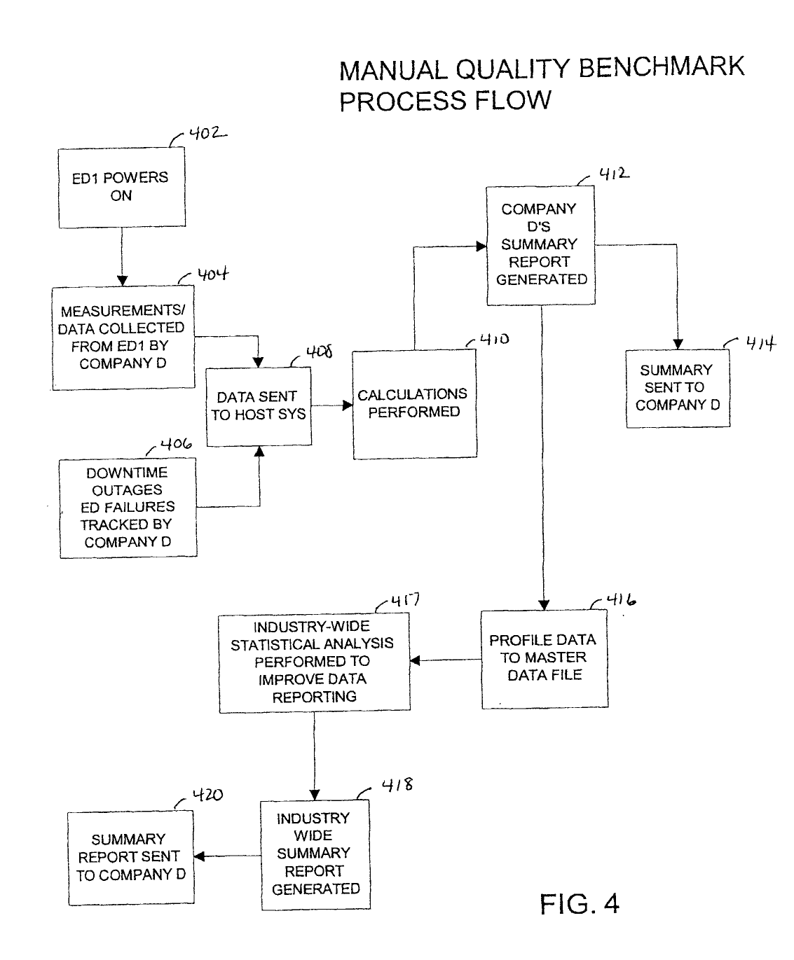

FIG. 1 for each of enterprises 120-150, any number of equipment devices may be employed. Further, it is not necessary that enterprises 120, 130 and 140 communicate via the Internet to achieve the advantages of the present invention. Any suitable network configuration will suffice, such as extranet or wireless technologies. Enterprise 150 is also included in system 100 however, it is not connected to the Internet. Enterprise 150 operates three equipment devices 127d, 128d, and 129d which are physically attended by personnel of enterprise 150 in order to collect data for analysis by the multi-enterprise benchmarking tool. This process is described further in FIG. 4.

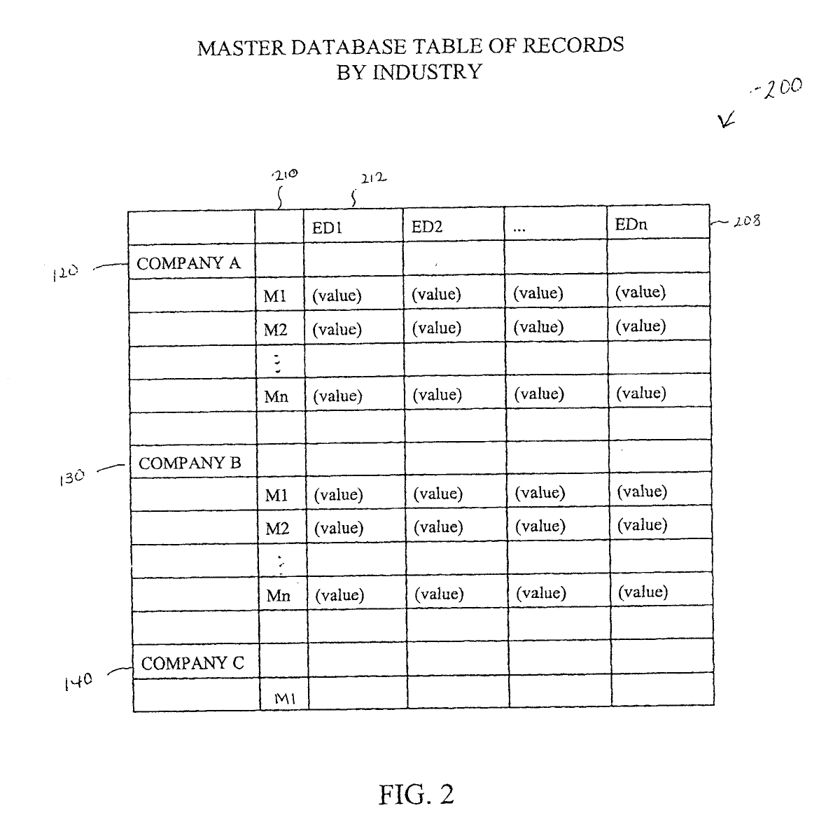

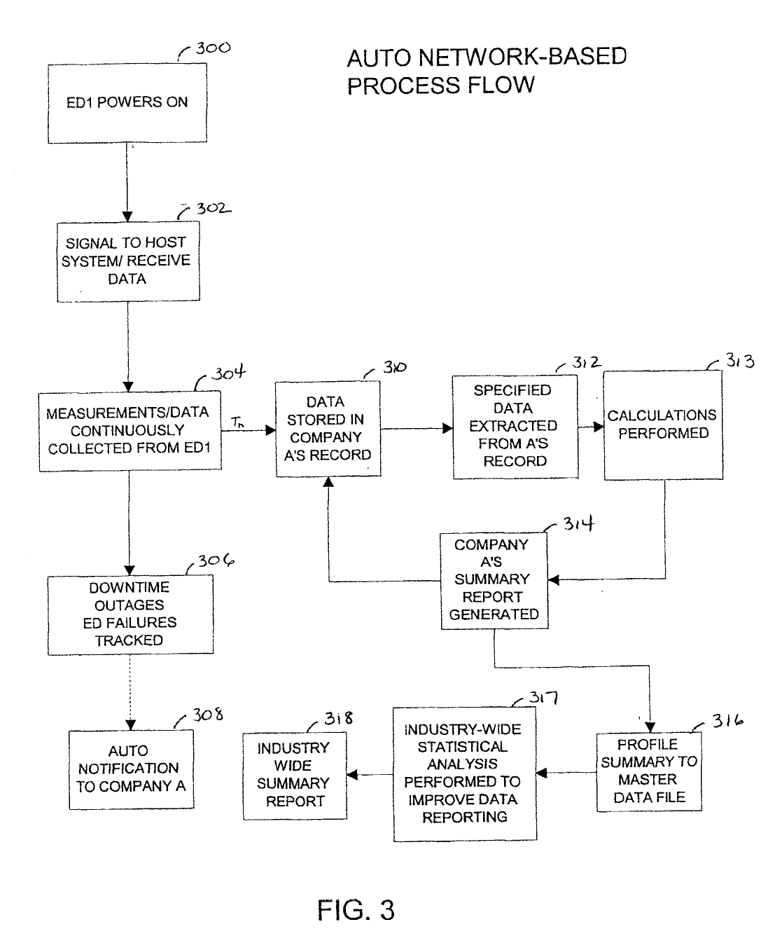

FIG. 2 illustrates an exemplary master database table 200 containing records of subscribing enterprises or companies for a given industry. Table 200 lists three participating companies, Company A 120, Company B 130 and Company C 140. Within each of companies 120, 130 and 140 there are operating manufacturing equipment devices ED₁ through EDₙ, where ‘n’ is any variable indicating the quantity of equipment devices utilized by each of companies A 120, B 130, and C 140. Equipment devices ED₁ through EDₙ are listed in row 208 of Table 200. Further, each equipment device supports a number of metrics fields indicating performance factors to be measured by the multi-enterprise benchmarking tool and are indicated in Table 200 as M₁ through Mₙ in column 210. Thus, for example, column 212 lists values associated with metrics obtained by equipment device ED₁ for each of companies A 120, B 130, and C 140. ED₁ correlates to Company A's 120 equipment device 127a, Company B's 130 equipment device 127b, Company C's 140 equipment device 127c, and Company D's 150 equipment device 127d of FIG. 1. Values provided in these fields may be either numeric or other quantifiable measurement, depending upon the type of performance metric specified. Any number of companies may be participators in the multi-enterprise benchmarking program so long as they fall within an industry category defined by the multi-enterprise benchmarking tool. Additionally, considerable numbers of metrics fields M₁ through Mₙ may be established by the multi-enterprise benchmarking tool and selected for measurement by participating enterprises. Likewise, the multi-enterprise benchmarking tool is capable of providing measurement collection and analysis for any number of equipment devices ED₁ through EDₙ for a given company or customer. Once collected, this raw data is transferred to a database in data storage device 110 in accordance with a subscriber's individual preferences for analysis and reporting by the multi-enterprise benchmarking tool and which is further described in FIGS. 3 and 4. Subscribing enterprises such as enterprises 120, 130, and 140 may download or receive an individual summary reports relating personal performance data by choosing any criteria or field available via the multi-enterprise benchmarking tool and desired by the company. Summary data includes not only the subscriber's performance measurements, but also how these measurements compare with industry standards. Low measurements in identified categories can be used by a subscriber to catalyze the implementation of new manufacturing or business process plans. Further, a subscribing enterprise may adjust or redefine its performance or production metrics requirements via the multi-enterprise benchmarking tool to accommodate changing business needs.

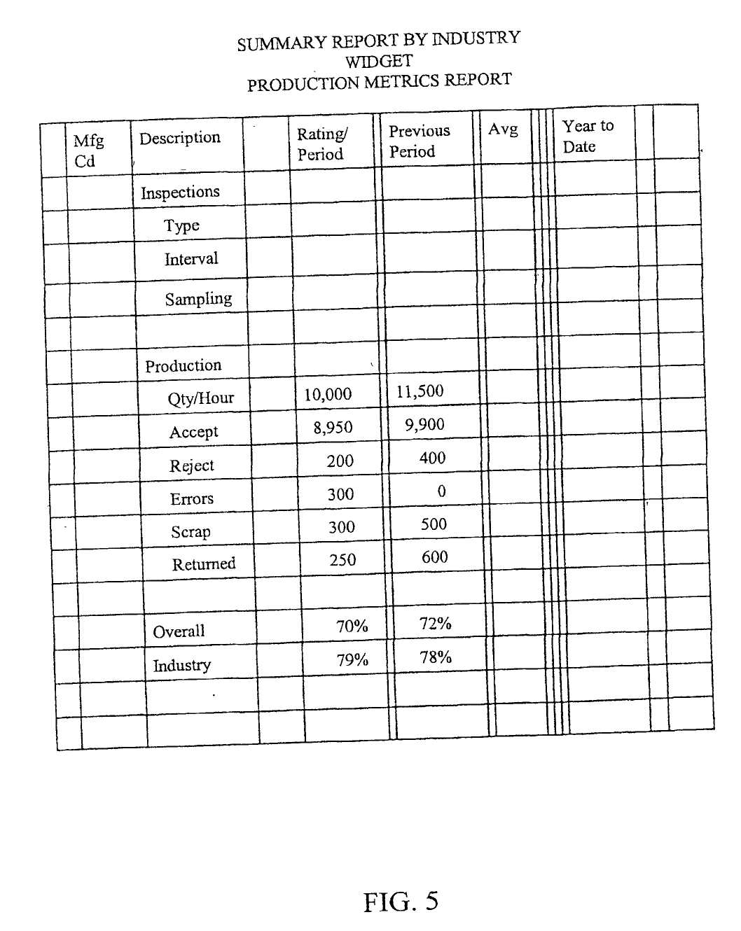

FIG. 3 illustrates the multi-enterprise benchmarking process flow via a network system as implemented by a subscriber such as enterprise 120, 130, or 140 of FIG. 1. Utilizing enterprise 120 as an example, a first equipment device 127a is powered on and begins operations at step 300. Equipment device 127a feeds data to workstation 122a which in turn alerts system 102 to receive data via servers 124a and 104 over the Internet at step 302. Workstation 122a then begins to feed the data received by equipment device 127a automatically and directly to system 102 for processing at step 304. Down times, system failures, and power outages are all tracked by the multi-enterprise benchmarking tool at step 306 and used to explain or support the performance data (or lack thereof) for reporting and analysis purposes. Notifications or warnings of such failures may also be automatically transmitted to Company A 120 for information and corrective action at step 308. Types of data collected vary according to the nature of equipment device being used by an enterprise. Hard data is collected but also soft or ‘fuzzy’ data such as materials performance, defect density, vendor support and services, vendor-managed inventory, etc. are collected. At a predefined time interval, or Tₙ, the data collected is transferred to Company A's 120 account in storage for further processing at step 310. Tₙ may be a time frame for collecting data such as an increment of minutes, hours, days, etc., and may be determined by Company A 120 and/or the multi-enterprise benchmarking tool. Specified data from Company A's 120 account is extracted periodically from storage at step 312 where the multi-enterprise benchmarking application performs calculations on the data (313). These calculations can include any number or types of statistical functions or equations relevant in the art, and may produce output numbers indicating an enterprise's production process complete with R² values when integrating supplier value, waste (e.g., engineering oversight, management inefficiency due to lower K production methods, etc.). Once completed, the multi-enterprise benchmarking tool generates a comprehensive summary report tailored to Company A 120 at step 314. A profile summary is generated from the summary report and delivered to the master data file database at step 316. Statistical analysis is performed on this data along with data summaries from other subscribers such as enterprises 130, 140, and 150 for improved data reporting at step 317. An industry-wide summary report 500 is generated at step 318 where it can be automatically transferred to subscribing companies 120, 130, and 140 or downloaded on demand. All confidential information is removed from report 500 so that subscribing companies 120-150 will not know the identities of the competitors or fellow subscribers in the report except that each subscribing company 120-150 will know how it is rated in the mix of subscribers. The summary report may provide a cost of ownership indicator, apprising soft costs and hard cost giving active participating subscribers a fair value to which their process can be compared. This comparison an occur on a regular and real time basis since it is always calculating through timely updates via the web. A sample summary report 500 is illustrated in FIG. 5.

FIG. 4 is a flowchart describing the multi-enterprise benchmarking process as implemented by non-networked and/or non-automated industry subscribers such as Company D 150 in FIG. 1. These customers are either not connected to the Internet or have equipment that is not automated or connected to a computer processor. The equipment devices 127d, 128d, and 129d employed by Company D 150 generate data which is manually transcribed or related to personnel of Company D 150 and must be physically relayed or delivered to the multi-enterprise benchmarking tool. To illustrate, at step 402 equipment device 127d is powered on. Various measurements are collected from equipment device 127d by Company D at step 404, as well as equipment failures at step 406 and are sent to the multi-enterprise benchmarking system at step 408. Delivery may be by telephone, regular mail, facsimile, or other generally known means of delivery known in the art. The multi-enterprise benchmarking tool performs calculations on the measurements at step 410 similar to those described in FIG. 3 and generates a summary report at step 412. A hard copy is sent to Company D 150 at step 414, and a digital copy is delivered to the profile master data file in data storage device 110 at step 416. Statistical analysis is performed on this data along with data summaries from other subscribers such as enterprises 130, 140, and 150 for improved data reporting at step 417. An industry-wide summary report 500 is generated by the tool at step 418 and a hard copy is delivered to Company D 150 at step 420.

FIG. 5 is a sample summary report 500 broken down for a specified industry. Summary report 500 details performance indicators relating to inspections and production metrics processed by the multi-enterprise benchmarking tool. The enterprise for which this report was generated has an overall efficiency rating of 70% for the current period 504. This means that the enterprise rates among its competitors in the 70^{th} percentile. This figure compares to the previous period 506, in which the enterprise was rated at 72%. The efficiency rating rules are pre-defined by the multi-enterprise benchmarking tool. The criteria used to rate the subscribing enterprises, and the types of metrics measured vary by industry and/or subscriber. As this information can be updated frequently, subscribers are better able to make instant business decisions in response to changing values and performance indicators. Additionally, a subscriber may develop employee incentive plans targeted to those areas found to be in need of improvement utilizing this data. These reports can also be used as a tool to entice existing and potential trading partners to acquire and maintain business relationships with the subscriber. Simply knowing that a subscriber is participating in such a program and that various benchmarking tools are in place may itself provide reassurance and added confidence in third parties who are considering doing business with the subscriber. Trusted vendors may even be permitted access to on-line viewing of a subscriber's reports for motivating such vendors to maintain existing partnerships and dealings.

Having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such a over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor the create specific logic circuits.

1. A method for facilitating benchmarking activities and performance analysis among multiple enterprises via a network connection, comprising:
receiving metrics data at a web site from at least one equipment device associated with a first subscribing enterprise;
receiving metrics data at a web site from at least one equipment device associated with a second subscribing enterprise;
evaluating said metrics data from said first subscribing enterprise and said second subscribing enterprise;
providing a first summary report to said first subscribing enterprise based upon said evaluating;
providing a second summary report to said second subscribing enterprise based upon said evaluating;.
transmitting said first summary report and said second summary report to a master data file;
performing calculations on said first summary report and said second summary report;
generating an industry summary report based upon said calculating;
providing said industry summary report to said first subscribing enterprise and said second subscribing enterprise;
wherein said benchmarking activities and said performance analysis are executed by a multi-enterprise benchmarking application.

2. The method of claim 1, wherein said benchmarking activities are defined by industry standards.

3. The method of claim 1, wherein said benchmarking activities are defined by said multi-enterprise benchmarking application.

4. The method of claim 1, wherein said benchmarking activities are defined by industry subscribing enterprises.

5. The method of claim 1, wherein said metrics data includes soft process performance metrics.

6. The method of claim 1, wherein said network connection is an extranet.

7. A storage medium encoded with machine-readable computer program code for facilitating benchmarking activities and performance analysis among multiple enterprises via a network connection, the storage medium including instructions for causing a computer to implement a method comprising:
receiving metrics data at a web site from at least one equipment device associated with a first subscribing enterprise;
receiving metrics data at a web site from at least one equipment device associated with a second subscribing enterprise;
evaluating said metrics data from said first subscribing enterprise and said second subscribing enterprise;
providing a first summary report to said first subscribing enterprise based upon said evaluating;
providing a second summary report to said second subscribing enterprise based upon said evaluating;
transmitting said first summary report and said second summary report to a master data file;
performing calculations on said first summary report and said second summary report;
generating an industry summary report based upon said calculating;
providing said industry summary report to said first subscribing enterprise and said second subscribing enterprise;
wherein said benchmarking activities and said performance analysis are executed by a multi-enterprise benchmarking application.

8. The storage medium of claim 7, wherein said benchmarking activities are defined by industry standards.

9. The storage medium of claim 7, wherein said benchmarking activities are defined by said multi-enterprise benchmarking application.

10. The storage medium of claim 7, wherein said benchmarking activities are defined by industry subscribing enterprises.

11. The storage medium of claim 7, wherein said metrics data includes soft process performance metrics.

12. The storage medium of claim 7, wherein said network connection is an extranet.

13. A system for facilitating benchmarking activities and performance analysis among multiple enterprises via a network connection, comprising:
a hosting enterprise including:
a server;
a workstation;
a firewall;
a data storage device; and
a network connection for allowing said server, said workstation, said firewall, and said data storage device to communicate;
a plurality of subscribing enterprises, each of said subscribing enterprises comprising:
a server;
a workstation;
at least one equipment device; and
a network connection for allowing said server, said workstation, and said at least one equipment device to communicate; and
a communications network for allowing each of said plurality of subscribing enterprises to communicate with said hosting enterprise; wherein said hosting enterprise is executing a multi-enterprise benchmarking software application.
